(19) United States
(12) Patent Application Publication
(10) Pub. No.: US 2025/0059812 A1
(43) Pub. Date: Feb. 20, 2025

(54) SYNCHRONIZING DEVICE FOR MOVING A MOVABLE FURNITURE PART

(71) Applicant: Julius Blum GmbH, Hoechst (AT)

(72) Inventors: Wolfgang BOHLE, Goetzis (AT); Sarah Scheffknecht, Krumbach (AT)

(21) Appl. No.: 18/939,091

(22) Filed: Nov. 6, 2024

Related U.S. Application Data
(63) Continuation of application No. PCT/AT2023/060111, filed on Apr. 5, 2023.

(30) Foreign Application Priority Data
May 13, 2022 (AT) GM 50082/2022

(51) Int. Cl. E05D 15/40

(52) U.S. Cl. CPC E05D 15/403; E05Y 2201/604

(57) ABSTRACT

A synchronization device includes at least two drive devices for moving a movable furniture part and a synchronization rod for synchronizing a movement of the drive devices. A first end region of the synchronization rod is connected to a first pivoting member of the first drive device, and a second end region of the synchronization rod is connected to a second pivoting member of the second drive device. A length compensating device is configured to at least partially compensate for a play between the drive devices and the synchronization rod along a longitudinal direction of the synchronization rod in a mounted condition of the synchronization rod. At least one of the drive devices includes a housing, and the length compensating device is at least partially integrated into the housing and/or the length compensating device is at least partially integrated into the synchronization rod.

The present application is a continuation of International Application PCT/AT2023/060111 filed on Apr. 5, 2023. Thus, all of the subject matter of International Application PCT/AT2023/060111 is incorporated herein by reference.

### BACKGROUND OF THE INVENTION

The present invention relates to a synchronization device comprising at least two drive devices for moving a movable furniture part and at least one synchronization rod for synchronizing a movement of the at least two drive devices. A first end region of the synchronization rod is configured to be connected to a first pivoting member of the first drive device, and a second end region of the synchronization rod is configured to be connected to a second pivoting member of the second drive device. At least one length compensating device is configured to at least partially compensate for a play between the drive devices and the synchronization rod in a direction extending in a longitudinal direction of the synchronization rod in a mounted condition of the synchronization rod.

WO 2013/040611 A1 discloses a synchronization device having a synchronization rod for synchronizing two drive devices. Such a synchronization device has the purpose that the movable furniture part can always be guided with a uniform distance with respect to a furniture carcass, in particular also in the case when the movable furniture part is decentrally actuated by a manual force application. The synchronization rod is configured to be connected to the two drive devices, also when the two drive devices have already been pre-mounted to a furniture carcass. A necessary requirement for an optimal synchronization is that the play occurring in the longitudinal direction of the synchronization rod can be compensated for. For this purpose, at least one pivoting member of the drive devices includes a spring-loaded pressing portion configured to bear against the front face of the synchronization rod, so that a longitudinal play can be compensated by the spring-loaded pressing portion. A drawback of this construction is the fact that the drive device with the spring-loaded pressing portion has a relatively bulky construction.

### SUMMARY OF THE INVENTION

It is an object of the present invention to propose a synchronization device of the type mentioned in the introductory part, having a compact construction.

According to the invention, at least one of the drive devices includes a housing, and the length compensating device is at least partially integrated into the housing and/or the length compensating device is at least partially integrated into the synchronization rod.

In other words, the length compensating device for compensating for a longitudinal play of the synchronization rod is integrated into the housing of the drive device and/or into the synchronization rod itself. In this way, the drive device and/or the synchronization rod can be designed in a more compact manner.

According to preferred embodiments, the synchronization rod:
is configured to be releasably connected to the pivoting members of the drive devices, also when the drive devices have already been pre mounted, in particular to a furniture carcass, and/or
is connected to the pivoting members of the drive devices in a torque-proof manner in a mounted condition, and/or
is pre-stressed relative to the two pivoting members of the drive devices with a predetermined holding force by the length compensating device between the two opposing pivoting members of the two drive devices in a longitudinal direction of the synchronization rod, and is held between the two pivoting members in a longitudinal direction of the synchronization rod without play, and/or
is configured to be invariable in length.

Basically, the synchronization device can be used anywhere a pivoting movement of two drive devices is to be synchronized, for example also for synchronously triggering of so-called Touch-Latch devices configured the eject movable furniture parts from the closed end position. This Touch-Latch functionality provides for ejecting movable furniture parts by exerting a pressure or a pulling force to the movable furniture part when located in the closed position.

The synchronization device can be used for synchronizing a movement of movable furniture parts, in particular doors, flaps or drawers, or also for synchronizing of a movement of other movable elements, such as windows for example.

### BRIEF DESCRIPTION OF THE DRAWINGS

Further details and advantages of the present invention will be apparent from the following description of figures, in which:

FIG. 1a, 1b show an item of furniture in the form of a liftable flap and the synchronization device to be mounted to the item of furniture in perspective views,

FIG. 2a-2d are a perspective view and a detail view of the synchronization device,

FIG. 3a-3d are a perspective view and a cross-sectional view of a pivoting member with an integrated length compensating device in two different operating positions,

FIG. 4a, 4b are a perspective view and a cross-sectional view of a synchronization rod coupled to the pivoting member,

FIG. 5a, 5b are a perspective view and a cross-sectional view of an embodiment of a synchronization rod with a partially integrated length compensating device,

FIG. 6a-6e show the length compensating device according to FIGS. 5a, 5b in different views,

FIG. 7a-7c show a further embodiment of a length compensating device,

FIG. 8a-8c show a further embodiment of a length compensating device,

FIG. 9a, 9b show a synchronization rod in a perspective view and a length compensating device in an exploded view,

FIG. 10a-10c show the length compensating device according to FIG. 9b in different views,

FIG. 11a, 11b show a further embodiment of a length compensating device in two different views,

FIG. 12a, 12b show the embodiment of the length compensating device according to FIG. 11a, 11b in two different perspective views, and

FIG. 13 shows the length compensating device according to FIG. 12a, 12b in an exploded view.

### DETAILED DESCRIPTION OF THE INVENTION

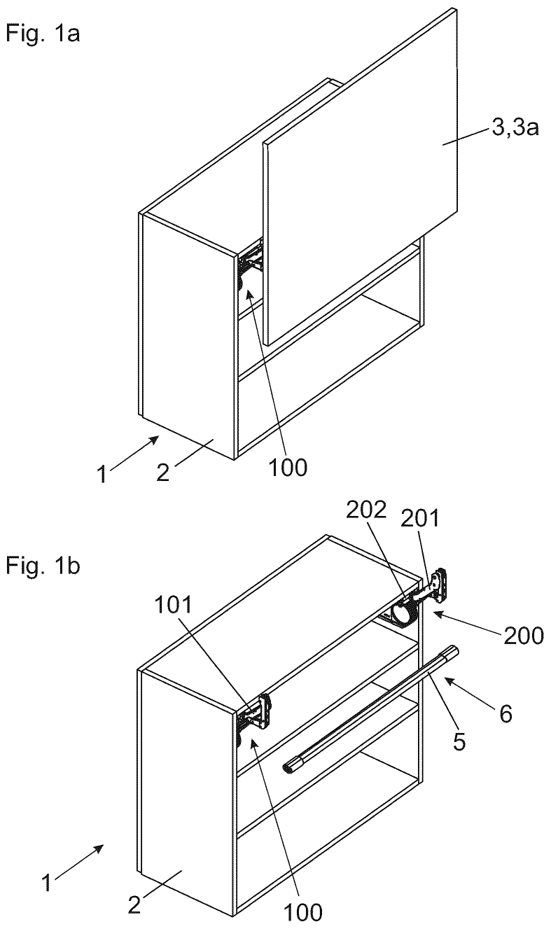

FIG. 1a shows an item of furniture 1 comprising a furniture carcass 2 and a movable furniture part 3 in the form of a flap 3a, the flap 3a being movably supported relative to the furniture carcass 2 via two drive devices 100, 200.

In FIG. 1b, the movable furniture part 3 is hidden so that the drive devices 100, 200 mounted to the opposing sidewalls can be seen. The two drive devices 100, 200, collectively with a synchronization rod 5, form a synchronization device 6 for moving the movable furniture part 3.

In the shown embodiment, each of the two drive devices 100, 200 includes at least one pivotable actuating arm 101, 201, the actuating arm 101, 201 being preferably pivotable about a horizontally extending axis. The actuating arm 101, 201 is configured to be connected to the movable furniture part 3.

With each of the actuating arms 101, 201, a pivoting member 102, 202 is connected in a movement-coupled manner. The pivoting member 102 of the left drive device 100 does not emerge in the illustration shown in FIG. 1b. The synchronization rod 5 is in the form of a torsional shaft provided for the synchronization of a movement of the two drive devices 100, 200 so as to establish a coupled, synchronized pivoting movement of the two pivoting members 102, 202 of the two drive devices 100, 200. Of course, it is also possible that the pivoting member 102, 202 is formed by one of the actuating arms 101, 201.

Preferably, the synchronization rod 5 extends substantially in a horizontal direction in a mounted condition.

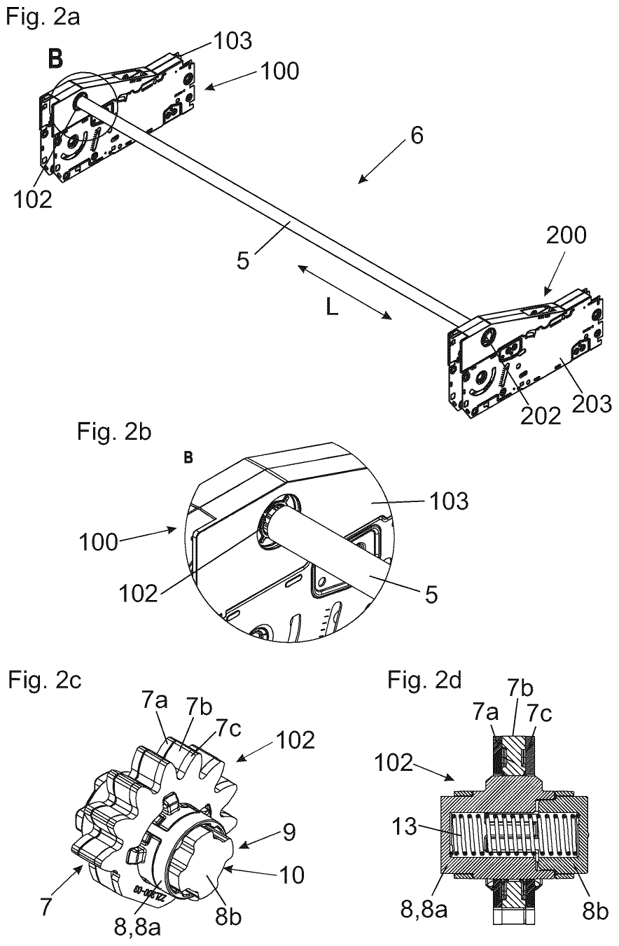

FIG. 2a shows an embodiment of a synchronization device 6 in perspective view. Each of the drive devices 100, 200 includes a housing 103, 203 configured to be fixed to a furniture carcass 2, and at least one pivoting member 102, 202 configured to be releasably connected to the synchronization rod 5. The housing 103, 203 can be formed by at least two housing walls spaced apart from each other at least over a region. The synchronization rod 5 has a longitudinal direction L, and is connected to the pivoting members 102, 202 of the drive devices 100, 200 in a torque-proof manner in a mounted condition. As a result, upon a movement of a pivoting member 102, 202, the synchronization rod 5 is also entrained therewith.

According to an embodiment, at least one of the drive devices 100, 200 includes at least one actuating arm 101 (FIG. 1b) pivotable about at least a first pivoting axis for moving the movably-supported furniture part 3 relative to the housing 103, 203, and the pivoting member 102, 202 of the drive device 100, 200 is arranged laterally offset with respect to the first pivoting axis of the actuating arm 101, 201.

FIG. 2b shows the encircled region “B” of FIG. 2a in an enlarged view. In the shown embodiment, each of the pivoting members 102, 202 is integrated into the housing 103, 203, thereby providing a very compact construction of the drive devices 100, 200.

FIG. 2c shows an embodiment of a pivoting member 102 which is at least partially, preferably substantially entirely, integrated into the housing 103 of the drive device 100. Each of the pivoting members 102, 202 includes an interface 10 configured to be releasably connected to the synchronization rod 5.

According to possible embodiments, at least one of the pivoting members 102, 202
includes at least one tooth arrangement 7, preferably wherein the tooth arrangement 7 includes at least two tooth segments 7a, 7b, 7c bearing in layers against each other in a longitudinal direction L of the synchronization rod 5, and/or
is supported on a shaft 8, and the length compensating device 9 is integrated into the shaft 8, and/or
is integrated into the housing 103, 203 of the drive device 100, 200, and/or
includes at least two components 8a, 8b configured to be moved relative to each other in the longitudinal direction L of the synchronization rod 5, preferably wherein the components 8a, 8b are pre-stressed relative to each other by at least one force storage member 13 (FIG. 2d) and/or are telescopically movable relative to each other.

According to possible embodiments, one of the at least two tooth segments 7a, 7b, 7c consists of a first material and the other of the tooth segments 7a, 7b, 7c consists of a second material, the second material having a lower hardness than the first material. Preferably, the first material is steel and/or the second material is plastic.

FIG. 2d shows the pivoting member 102 according to FIG. 2c in a cross-sectional view. It can be seen that the pivoting member 102 includes at least two components 8a, 8b displaceable relative to each other, the components 8a, 8b being pre-stressed relative to each other by a force storage member 13, preferably in the form of a compression spring.

The component 8b is configured such that the component 8b is configured to be connected to the synchronization rod 5 in a form-locking manner, so that a torque transmission can be established between the pivoting member 102 and the synchronization rod 5. For this purpose, each of the pivoting members 102, 202 can include an interface 10 configured to be releasably coupled to the synchronization rod 5.

According to a further embodiment, at least two tooth segments 7a, 7b, 7c are arranged so as to bear in layers against each other in a longitudinal axis L of the synchronization rod 5, and a tooth segment 7b of the at least two tooth segments 7a, 7b, 7c projects in a radial direction over the other of the tooth segments 7a, 7c. In this way, the occurring play between the pivoting member 102, 202 and a transmitting element (not shown) meshing with the pivoting member 102, 202 can be reduced.

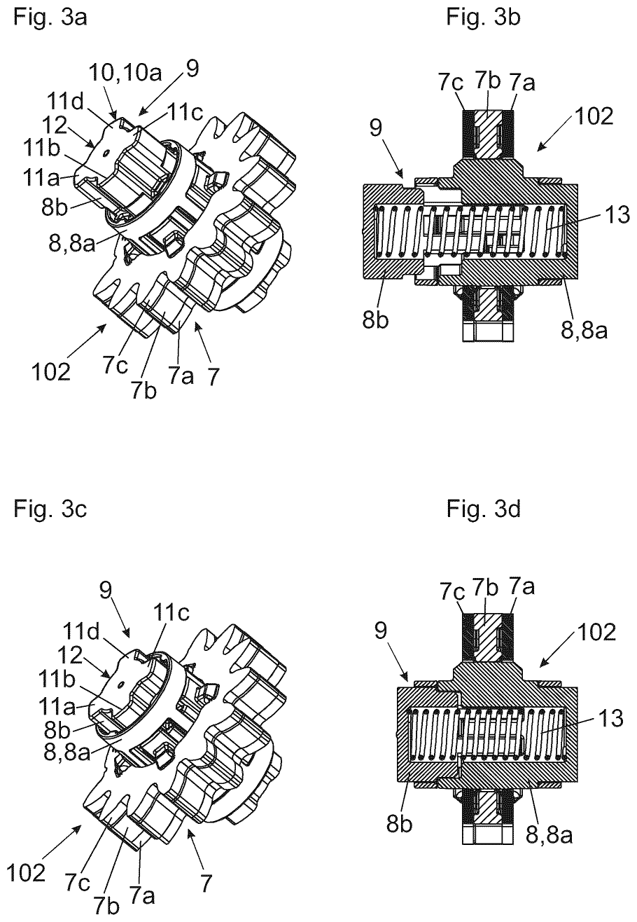

FIG. 3a shows a perspective view of a pivoting member 102 with a length compensating device 9 integrated into the pivoting member 102. The tooth arrangement 7 with the three tooth segments 7a, 7b, 7c bearing in layers against each other can be seen. For example, the two outer tooth segments 7a, 7c can be made of metal and the central tooth segment 7b can be made of plastic, and the central tooth segment 7b projects over the two outer tooth segments 7a, 7c.

The pivoting member 102 includes an interface 10 configured to be releasably connected to the synchronization rod 5. According to possible embodiments, the interface 10:
is configured such that the synchronization rod 5 is connectable to the pivoting member 102 only in one single pivoting position within a pivoting angle range of 360°, and/or
includes an assembling portion 10a having an outer contour deviating from a circular form for receiving the synchronization rod 5 in a form-locking manner, preferably wherein the outer contour includes, over a region, a plurality of protrusions 11a, 11b, 11c, 11d arranged substantially equidistantly in the pivoting direction, and further includes a flattening 12 or a recess which is arranged instead of a protrusion 11a, 11b, 11c, 11d. This construction allows that the synchronization rod 5 is connectable to the pivoting member 102 only in one single pivoting position within a pivoting angle range of 360°.

FIG. 3b shows the pivoting member 102 according to FIG. 3a in a cross-sectional view. It can be seen that the components 8a, 8b are pre-stressed relative to each other by a force storage member 13, and the component 8b is located in an extended position relative to the other component 8a. In this position, a maximum occurring play of the synchronization rod 5 relative to the pivoting member 102 can be compensated for.

FIG. 3c shows the pivoting member 102 with a component 8b located in a retracted position relative to the other component 8a. In this position, a minimum occurring play of the synchronization rod 5 relative to the pivoting member 102 can thus be compensated for.

FIG. 3d shows the pivoting member 102 according to FIG. 3c in a cross-sectional view.

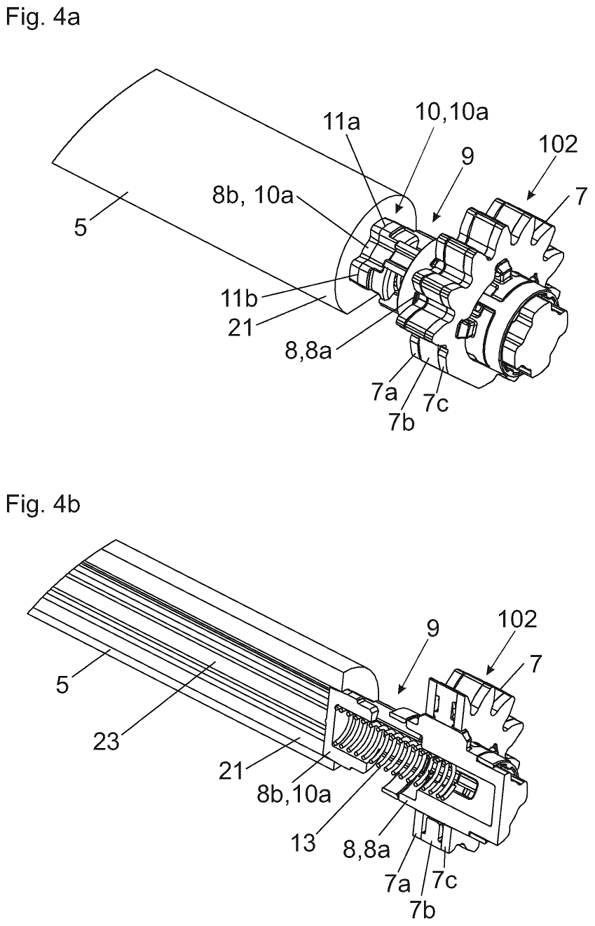

FIG. 4a shows a perspective view of a synchronization rod 5 coupled to the pivoting member 102. It can be seen that the protrusions 11a, 11b of the component 8b configured as an assembling portion 10a engage into an end region of the synchronization rod 5 in a form-locking manner.

The interface 10 can include an outer contour deviating from a circular form and a receiving portion 21 configured to receive the assembling portion 10a in a form-locking manner. In the shown embodiment, the receiving portion 21 is formed by the synchronization rod 5.

FIG. 4b shows a cross-sectional view of the synchronization rod 5 and of the pivoting member 102 according to FIG. 4a. At least one of the end regions of the synchronization rod 5 can include a cavity 23, and the length compensating device 9 is at least partially arranged within the cavity 23.

According to an embodiment, the length compensating device 9 includes at least one first force storage member 13 operating in the longitudinal direction L of the synchronization rod 5, and the force storage member 13 is at least partially arranged within the cavity 23 of the synchronization rod 5.

The synchronization rod 5 can have an identical cross-section over an entire length and/or can be configured over an entire length as a hollow profile having an identical inner diameter.

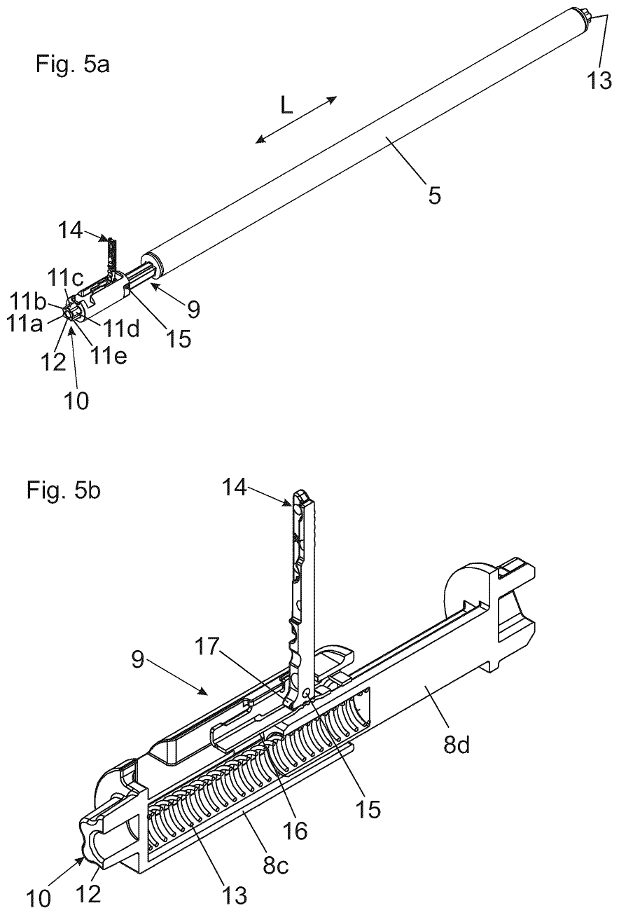

FIG. 5a shows a perspective view of an embodiment of a synchronization rod 5 with a partially integrated length compensating device 9 for compensating for a play occurring in a longitudinal direction L of the synchronization rod 5.

According to an embodiment, the length compensating device 9 is arranged on one of the end regions of the synchronization rod 5 only.

A first end region of the synchronization rod 5 includes a stationary outer contour 13 having a cross-section deviating from a circular form. The stationary outer contour 13 is configured to be connected to one of the pivoting members 102, 202 of the drive devices 100, 200 in a form-locking manner.

A second end region of the synchronization rod 5 includes a length compensating device 9 with an interface 10 configured to be releasably connected to a pivoting member 102, 202 of a drive device 100, 200. The interface 10 includes a plurality of protrusions 11a, 11b, 11c, 11d arranged substantially equidistantly in the pivoting direction, and further includes at least one flattening 12 or a recess which is arranged instead of a protrusion 11a, 11b, 11c, 11d.

According to an embodiment, the length compensating device 9 is connected or is connectable to the synchronization rod 5 in a friction-locked manner.

FIG. 5b shows the length compensating device 9 according to FIG. 5a in a cross-sectional view.

The length compensating device 9 includes at least one force storage member 13 operating in the longitudinal direction L of the synchronization rod 5 and/or at least one spring element 16 operating in a direction extending transversely to the longitudinal direction L of the synchronization rod 5. A play occurring in a direction extending transversely to the longitudinal direction L of the synchronization rod 5 can be compensated for by the spring element 16. For example, the spring element 16 can be in the form of a leaf spring.

The length compensating device 9 can include at least two connecting members 8c, 8d displaceably supported relative to each other, preferably in a limited manner, in the longitudinal direction L of the synchronization rod 5. The connecting members 8c, 8d are pre-stressed relative to each other by a force storage member 13, for example in the form of a compression spring.

In this embodiment, the length compensating device 9 includes at least one pivoting lever 14, the pivoting lever 14 being pivotally supported about a pivoting axis 15 between a release position and an arresting position, the pivoting axis 15 extending transversely to the longitudinal direction L of the synchronization rod 5.

The pivoting lever 14 includes a protrusion 17 configured to be pressed against the spring element 16 and thus against the component 8c upon an actuation of the pivoting lever 14 about the pivoting axis 15. In this way, the relative position of the mutually displaceable connecting members 8c, 8d of the length compensating device 9 is arrestable. The spring element 16 is supported on the pivoting lever 14 at least when the pivoting lever 14 is in the arresting position.

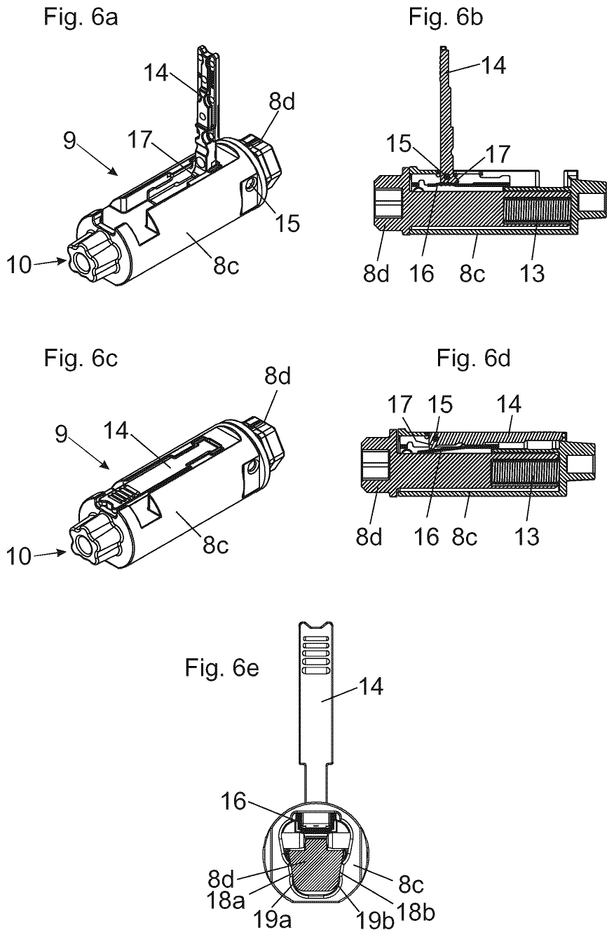

FIG. 6a-6e show the embodiment of the length compensating device 9 according to FIG. 5a, 5b in different views.

FIG. 6a shows the length compensating device 9 with the pivoting lever 14 in a release position. The two connecting members 8c, 8d are pre-stressed relative to each other by a force storage member 13, and an occurring longitudinal play of the synchronization rod 5 relative to the pivoting members 102, 202 of the two drive devices 100, 200 can be compensated for. Moreover, at least one additional spring element 16 is provided configured to compensate for a play occurring in a direction extending transversely to the longitudinal direction L between the two connecting members 8c, 8d.

FIG. 6b shows the length compensating device 9 according to FIG. 6a in a cross-sectional view. The spring element 16 in the form of the leaf spring can be seen, and a play occurring transversely to the longitudinal direction L can be compensated for by the spring element 16. The pivoting lever 14 is movably supported about the pivoting axis 15. The pivoting lever 14 includes an abutment 17 arranged adjacent to the pivoting axis 15, the abutment 17 being configured to bear against the spring element 16.

FIG. 6c shows the length compensating device 9 with the pivoting lever 14 in an arresting position in which the pivoting lever 14 is arranged flush with the substantially cylindrical connecting member 8c.

FIG. 6d shows the length compensating device 9 according to FIG. 6c in a cross-sectional view. By a movement of the pivoting lever 14 about the pivoting axis 15, the spring element 16 can be pressed against the inner connecting member 8d by the protrusion 17, and the relative position between the connecting members 8c, 8d is arrestable.

FIG. 6e shows a cross-sectional view of the length compensating device 9 with the pivoting lever 14 in a release position. The position of the pivoting lever 14 thus corresponds to the position shown in FIGS. 6a, 6b. The spring element 16 in the form of the leaf spring can have a U-shaped cross-section.

According to possible embodiments:
one of the connecting members 8c, 8d includes an outer contour having an inclined surface 18a, 18b, preferably two inclined surfaces 18a, 18b, and the other of the connecting members 8c, 8d includes an inner contour with a corresponding counterform 19a, 19b, and/or
one of the connecting members 8c, 8d includes an outer contour in the form of a hexagon, and/or
the connecting members 8c, 8d are displaceably supported, preferably in a limited manner, in a direction extending transversely to the longitudinal direction L of the synchronization rod 5.

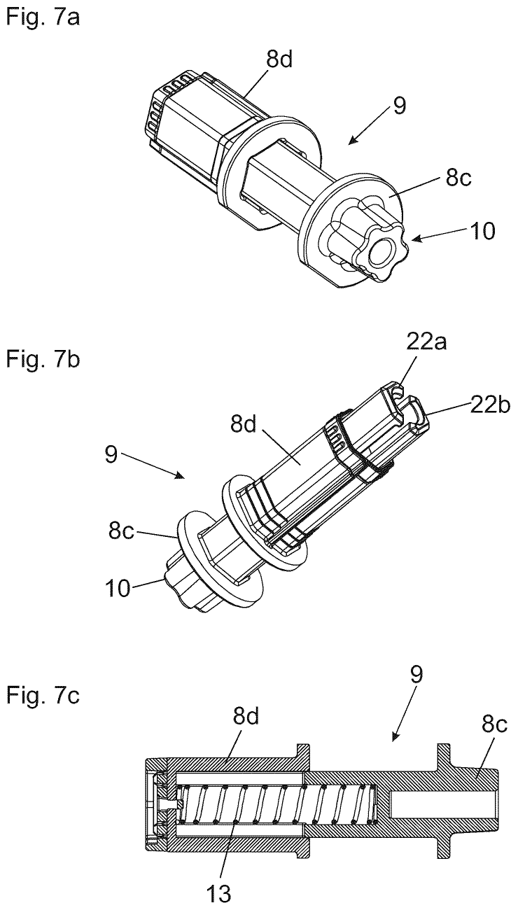

FIG. 7a-7c show a further embodiment of a length compensating device 9 with two connecting members 8c, 8d displaceable relative to each other, the two connecting members 8c, 8d being pre-stressed relative to each other in a longitudinal direction L of the synchronization rod 5 by a force storage member 13.

FIG. 7a shows the length compensating device 9 in a perspective view. At least of the connecting members 8c, 8d can have a section in the form of a hexagon.

FIG. 7b shows the length compensating device 9 in a further perspective view. The connecting member 8d includes at least one spring portion 22a, 22b, preferably two spring portions 22a, 22b, for fixing the length compensating device 9 to the synchronization rod 5. The at least one spring portion 22a, 22b can be introduced into a cavity 23 (FIG. 4b) of the synchronization rod 5, and the length compensating device 9 can be clampingly fixed within the cavity 23 of the synchronization rod 5b by a radial widening of the spring portion 22a, 22b.

FIG. 7c shows the length compensating device 9 according to FIGS. 7a, 7b in a cross-sectional view, in which the connecting members 8c, 8d are pressed apart from each other by the force storage member 13 in a longitudinal direction L of the synchronization rod 5.

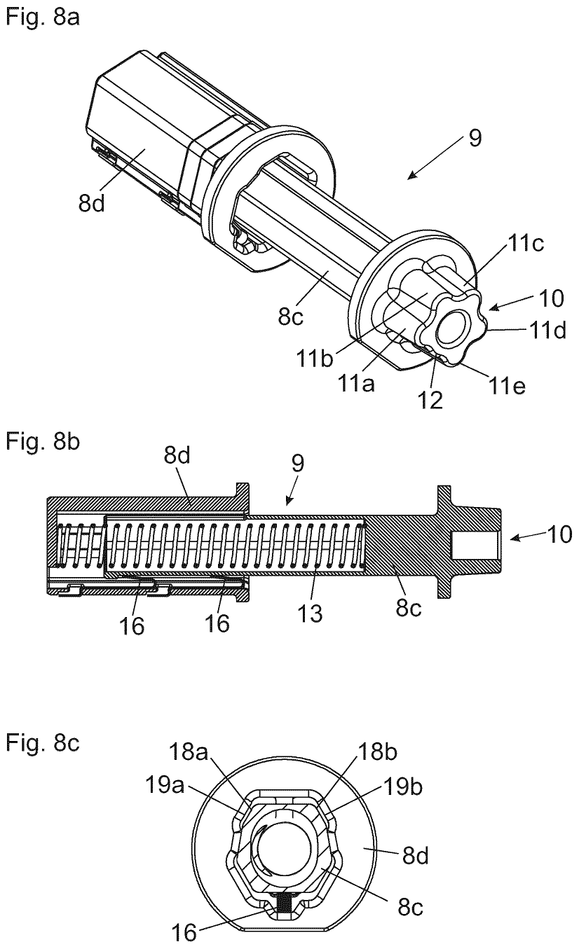

FIG. 8a-8c show a further embodiment of a length compensating device 9 with two connecting members 8c, 8d displaceable relative to each other. The two connecting members 8c, 8d are pre-stressed relative to each other by a force storage member 13 in a longitudinal direction L of the synchronization rod 5.

FIG. 8a shows a perspective view of the length compensating device 9. The interface 10 for releasably fixing the synchronization rod 5 can have a flattening 12 or a recess, the flattening or the recess being arranged instead of a protrusion 11a, 11b, 11c, 11d, 11e.

FIG. 8b shows the length compensating device 9 according to FIG. 8a in a cross-sectional view. To be seen are at least two spring elements 16 spaced apart from each other in a longitudinal direction L of the synchronization rod 5. By each of the at least two spring elements 16, a play occurring in a direction extending transversely to a longitudinal direction L of the synchronization rod 5 can be compensated for.

FIG. 8c shows an overlapping region of the two connecting members 8c, 8d in a cross-sectional view. One of the connecting members 8c, 8d has an outer contour with an inclined surface 18a, 18b, preferably two inclined surfaces 18a, 18b. The other of the two connecting members 8c, 8d has an inner contour with a corresponding counterform 19a, 19b. By a force of the spring elements 16, one connecting member 8c is pressed into the other connecting member 8d via the inclined surfaces 18a, 18b and the corresponding counterform 19a, 19b.

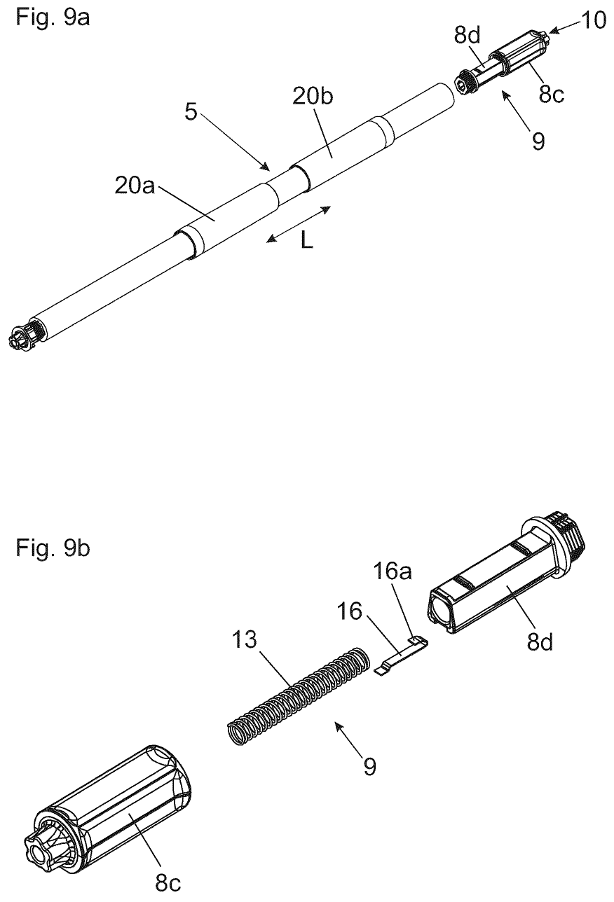

FIG. 9a shows a synchronization rod 5 in a perspective view. At least one cover element 20a, 20b can be provided, the at least one cover element 20a, 20b being displaceably arranged relative to the synchronization rod 5 in the longitudinal direction L of the synchronization rod 5. The at least one cover element 20a, 20b is configured to cover an end region of the synchronization rod 5. In the shown embodiment, the at least one cover element 20a, 20b is a substantially cylindrical sleeve displaceably supported along the synchronization rod 5.

FIG. 9b shows the length compensating device 9 illustrated in FIG. 9a in an exploded view. The two mutually displaceable connecting members 8c, 8d are pre-stressed by a force storage member 13 in a longitudinal direction L of the synchronization rod 5. In addition thereto, at least one spring element 16 is provided for compensating for a play occurring in a direction extending transversely to the longitudinal direction L. The spring element 16 includes a bent end 16a configured to bear against one of the connecting members 8c, 8d.

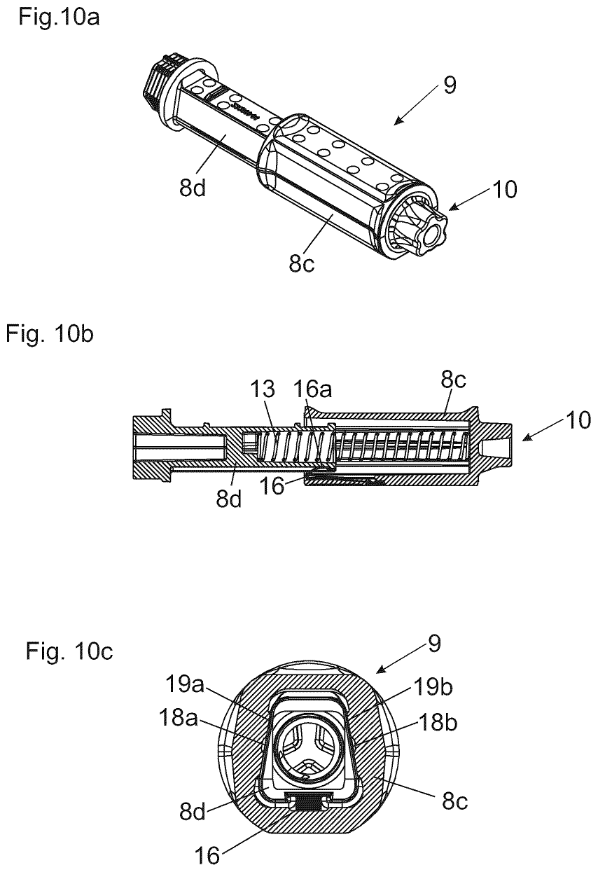

FIG. 10a-10c show the length compensating device 9 according to FIG. 9b in different views.

FIG. 10a shows the length compensating device 9 in a perspective view. The length compensating device 9 includes at least two connecting members 8c, 8d which are telescopically arranged relative to each other and which are pre-stressed relative to each other by at least one force storage member 13 in a longitudinal direction L of the synchronization rod 5.

FIG. 10b shows the length compensating device 9 according to FIG. 10a in a cross-sectional view. By an additional spring element 16, a play occurring in a direction extending transversely to the longitudinal direction L of the synchronization rod 5 can be compensated for. The bent end 16a of the spring element 16 is supported on a peripheral surface of the connecting member 8d, and besides the play compensation in a direction extending transversely to the longitudinal direction L, an extending movement of the two connecting members 8c, 8d relative to each other can be limited.

FIG. 10c shows the length compensating device 9 according to FIGS. 10a, 10b in a cross-sectional view. The inner connecting member 8d has inclined surfaces 18a, 18b configured to be pressed against the corresponding counterform 19a, 19b of the other connecting member 8c by a force of the spring element 16.

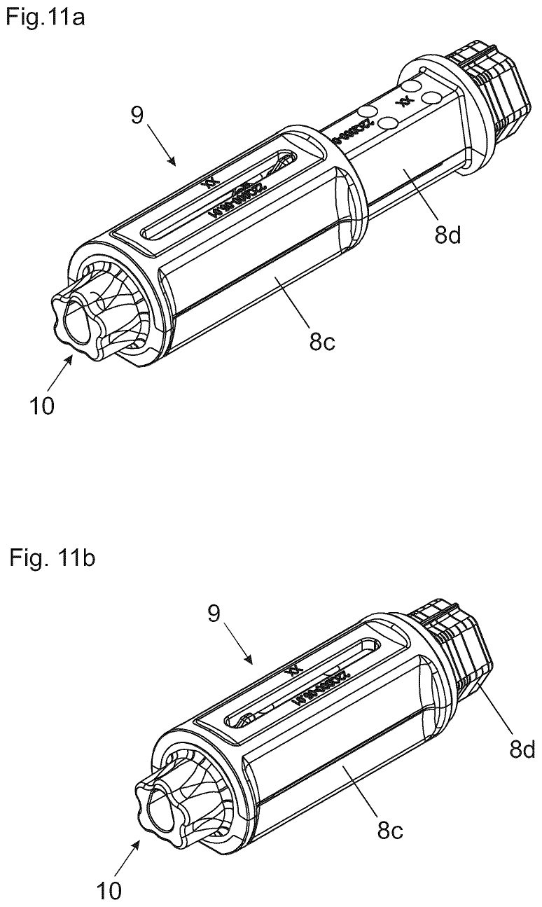

FIG. 11a and FIG. 11b show a further embodiment of a length compensating device 9.

FIG. 11a shows the length compensating device 9 with the two connecting members 8c, 8d in an extended condition.

FIG. 11b shows the length compensating device 9 with the two connecting members 8c, 8d in a compressed condition, in which the synchronization rod 5 is releasably connectable to a pivoting member 102, 202 of a drive device 100, 200 via the interface 10.

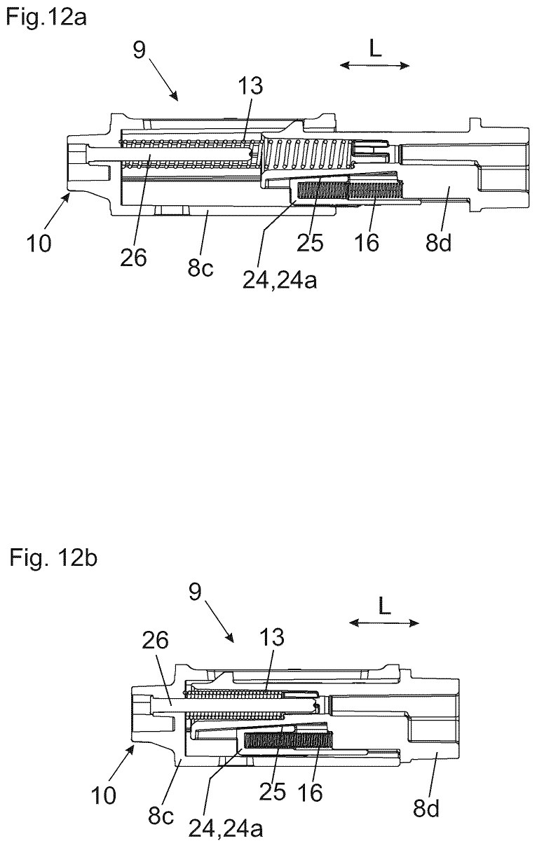

FIG. 12a and FIG. 12b show the length compensating device 9 according to the previous FIGS. 11a, 11b.

FIG. 12a shows the length compensating device 9 with the two connecting members 8c, 8d in an extended condition.

The length compensating device 9 includes at least one force storage member 13 operating in the longitudinal direction L of the synchronization rod 5, the two connecting members 8c, 8b being pre-stressed in the longitudinal direction L by the at least one force storage member 13.

In addition to the force storage member 13, the length compensating device 9 includes at least one play compensating element 24 operating in a direction extending transversely to the longitudinal direction L of the synchronization rod 5, and a play occurring in a direction extending transversely to the longitudinal direction L of the synchronization rod 5 can be compensated for by the at least one play compensating element 24.

According to possible embodiments, the at least one play compensating element 24:
is configured as a spring element 16, preferably wherein the spring element 16 is a leaf spring or a helical spring, and/or
includes at least one wedge element 24a having a wedge surface 25 extending inclinedly to the longitudinal direction L of the synchronization rod 5, preferably wherein the at least one wedge element 24a is pre-stressed by a spring element 16 in a direction extending parallel to the longitudinal direction L of the synchronization rod 5, and/or is displaceably supported in the longitudinal direction L of the synchronization rod 5.

According to a possible embodiment, the force storage member 13 and the spring element 16 are each configured as helical springs, and the longitudinal directions of the two helical springs extend substantially parallel to each other. As a result, a very compact arrangement can be made possible.

Accordingly, the additional play compensating element 24 serves for compensating for a play occurring in a direction extending transversely to the longitudinal direction L. However, the play compensating element 24 does not impede a movement of the connecting members 8c, 8d relative to each other in the longitudinal direction L.

Moreover, the play compensating element 24 is configured to be re-adjusting, so that a play occurring in a direction extending transversely to the longitudinal direction L can be automatically compensated for.

FIG. 12b shows the length compensating device 9 according to FIG. 12a in a compressed condition.

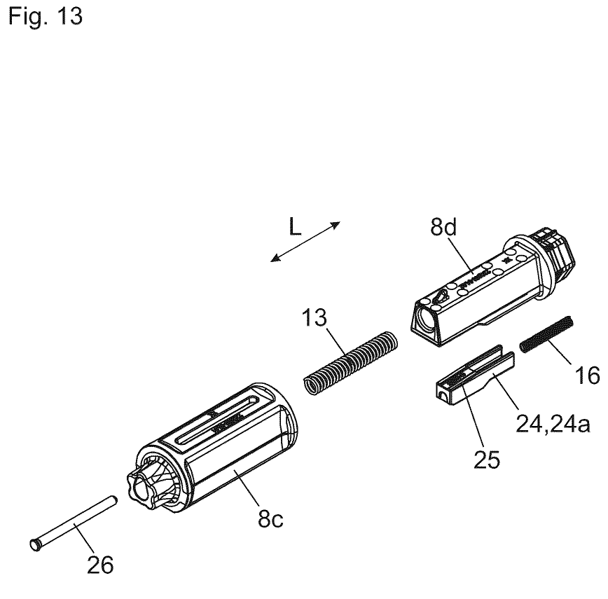

FIG. 13 shows the length compensating device 9 according to FIG. 12a, 12b in an exploded view.

By at least one stabilizing element 26, a bulging of the force storage member 13 in a direction extending transversely to the longitudinal direction L can be limited.

Due to the at least one play compensating element 24 with the wedge element 24a and the spring element 16, a play occurring in a direction extending transversely to the longitudinal direction L between the two connecting members 8c, 8d can be compensated for.

1. A synchronization device comprising
at least two drive devices for moving a movable furniture part;
at least one synchronization rod for synchronizing a movement of the at least two drive devices, a first end region of the synchronization rod being connected to a first pivoting member of the first drive device, and a second end region of the synchronization rod being connected to a second pivoting member of the second drive device;
at least one length compensating device configured to at least partially compensate for a play between the at least two drive devices and the synchronization rod in a direction extending in a longitudinal direction of the synchronization rod in a mounted condition of the synchronization rod, and
wherein at least one of the drive devices includes a housing, and the length compensating device is at least partially integrated into the housing and/or the length compensating device is at least partially integrated into the synchronization rod.

2. The synchronization device according to claim 1, wherein at least one of the pivoting members:
includes at least one tooth arrangement, preferably wherein the tooth arrangement includes at least two tooth segments bearing in layers against each other in a longitudinal direction of the synchronization rod, and/or
is supported on a shaft, and the length compensating device is integrated into the shaft, and/or
is integrated into the housing of the drive device, and/or
includes at least two components configured to be moved relative to each other in the longitudinal direction of the synchronization rod, preferably wherein the components are pre-stressed relative to each other by at least one force storage member and/or are telescopically movable relative to each other.

3. The synchronization device according to claim 1, wherein each of the pivoting members includes an interface for releasably fixing the synchronization rod.

4. The synchronization device according to claim 3, wherein the interface:
is configured such that the synchronization rod is connectable to the pivoting member only in one single pivoting position within a pivoting angle range of 360°, and/or
includes an assembling portion having an outer contour deviating from a circular form, and a receiving portion for receiving the assembling portion in a form-locking manner, preferably wherein the outer contour includes, over a region, a plurality of protrusions arranged substantially equidistantly in the pivoting direction, and further includes a flattening or a recess which is arranged instead of a protrusion.

5. The synchronization device according to claim 1, wherein the length compensating device includes at least one force storage member operating in the longitudinal direction of the synchronization rod.

6. The synchronization device according to claim 1, wherein the length compensating device includes at least one play compensating element operating in a direction extending transversely to the longitudinal direction of the synchronization rod, and a play occurring in a direction extending transversely to the longitudinal direction of the synchronization rod can be compensated for by the at least one play compensating element, preferably wherein the at least one play compensating element:
is configured as a spring element, preferably wherein the spring element is a leaf spring or a helical spring, and/or
includes at least one wedge element having a wedge surface extending inclinedly to the longitudinal direction of the synchronization rod, preferably wherein the at least one wedge element is pre-stressed by a spring element in a direction extending parallel to the longitudinal direction of the synchronization rod, and/or is displaceably supported in the longitudinal direction of the synchronization rod.

7. The synchronization device according to claim 1, wherein the length compensating device includes at least one pivoting lever pivotable about a pivoting axis between a release position and an arresting position, the pivoting axis extending transversely to the longitudinal direction of the synchronization rod.

8. The synchronization device according to claim 6, wherein the spring element is supported on the pivoting lever at least in the arresting position of the pivoting lever.

9. The synchronization device according to claim 1, wherein the length compensating device includes at least two connecting members displaceably supported relative to each other, preferably in a limited manner, in the longitudinal direction of the synchronization rod.

10. The synchronization device according to claim 9, wherein:
one of the connecting members includes an outer contour with an inclined surface, preferably two inclined surfaces, and the other of the connecting members includes an inner contour with a corresponding counterform, and/or
one of the connecting members includes an outer contour in the form of a hexagon, and/or
the connecting members are displaceably supported, preferably in a limited manner, in a direction extending transversely to the longitudinal direction of the synchronization rod.

11. The synchronization device according to claim 1, wherein the synchronization rod, on at least one of the end regions, includes at least one cavity and the length compensating device is at least partially arranged within the cavity, preferably wherein the length compensating device includes at least one first force storage member operating in the longitudinal direction of the synchronization rod, and the force storage member is at least partially arranged within the cavity of the synchronization rod.

12. The synchronization device according to claim 1, further comprising at least one cover element displaceably arranged relative to the synchronization rod in the longitudinal direction of the synchronization rod and being configured to cover an end region of the synchronization rod.

13. The synchronization device according to claim 1, wherein the length compensating device is arranged on the synchronization rod on one end region only.

14. The synchronization device according to claim 1, wherein the length compensating device is connected or is configured to be connected to the synchronization rod in a friction-locked manner.

15. The synchronization device according to claim 1, wherein at least one of the drive devices includes at least one actuating arm pivotable about a first pivoting axis for moving the movably-supported furniture part relative to the housing, wherein the pivoting member of the drive device is arranged laterally offset with respect to the first pivoting axis of the actuating arm.

16. The synchronization device according to claim 1, wherein the synchronization rod:
is configured to be releasably connected to the pivoting members of the drive devices, also when the drive devices have already been pre mounted, in particular to a furniture carcass, and/or
is connected to the pivoting members of the drive devices in a torque-proof manner in a mounted condition, and/or
is pre-stressed relative to the two pivoting members of the drive devices with a predetermined holding force by the length compensating device between the two opposing pivoting members of the two drive devices in a longitudinal direction of the synchronization rod, and is held between the two pivoting members in a longitudinal direction of the synchronization rod without play, and/or
is configured to be invariable in length, and/or
has an identical cross-section over an entire length, and/or
is configured as a hollow profile with an identical inner diameter over an entire length.
